(19) United States
(12) Patent Application Publication
(10) Pub. No.: US 2026/0213083 A1
(43) Pub. Date: Jul. 23, 2026

(54) SOLID ELECTROLYTIC CAPACITOR

(71) Applicant: Panasonic Intellectual Property Management Co., Ltd., Kadoma-shi, Osaka (JP)

(72) Inventors: Kazuya Yamasaki, KYOTO FU (JP); Eizo Fujii, OSAKA FU (JP); Kohei Goto, OSAKA FU (JP); Yuji Miyachi, SAGA KEN (JP)

(73) Assignee: Panasonic Intellectual Property Management Co., Ltd., Kadoma-shi, Osaka (JP)

(21) Appl. No.: 19/142,327

(22) PCT Filed: Dec. 21, 2023
(86) PCT No.: PCT/JP2023/046006

§ 371 Date: Jun. 23, 2025

(30) Foreign Application Priority Data
Dec. 26, 2022 (JP) 2022-208809

(51) Int. Cl. H01G 9/042; H01G 9/15

(52) U.S. Cl. CPC H01G 9/042; H01G 9/15

(57) ABSTRACT

A disclosed solid electrolytic capacitor includes an anode body, an anode wire, a dielectric layer, a solid electrolyte layer, a carbon layer, and a silver particle layer. The solid electrolyte layer is formed in such a manner as to cover an entire bottom surface, an entire side surface, and at least a portion of an end surface of the anode body. The carbon layer is formed in such a manner as to cover the entire bottom surface and a portion of the side surface, and not to cover the end surface of the anode body. The silver particle layer is formed in such a manner as to cover the entire bottom surface and a portion of the side surface, and not to cover the end surface. The carbon layer and the silver particle layer are formed in predetermined regions of the side surface.

### TECHNICAL FIELD

The present disclosure relates to a solid electrolytic capacitor.

### BACKGROUND ART

An example of a solid electrolytic capacitor includes an anode body constituted by a porous sintered body, a dielectric layer formed on the anode body, a solid electrolyte layer formed on the dielectric layer, and a cathode lead-out layer formed on the solid electrolyte layer. Various proposals have been made on the cathode lead-out layer.

Claim 1 of PTL 1 (Japanese Laid-Open Patent Publication No. 2005-117034) discloses “a solid electrolytic capacitor including a capacitor element that is covered with an exterior body and includes a dielectric oxide film layer, a semiconductor layer, a carbon paste layer, and a conductive layer successively layered on a surface of a sintered body of a valve metal or a conductive oxide to which an anode lead is connected, wherein only a surface of the sintered body to which the anode lead is connected is not provided with the carbon paste layer”.

Claim 1 of PTL 2 (International Patent Application Publication No. 2007/004511) describes “a method for manufacturing a capacitor element wherein a treatment for coating a capacitor element with a conductive paste includes a step of immersing only a leading end of the capacitor element in a conductive paste bath and a step of immersing an entire region to be coated with the conductive paste in the conductive paste bath”.

### CITATION LIST

### Patent Literature

PTL 1: Japanese Laid-Open Patent Publication No. 2005-117034
PTL 2: International Patent Application Publication No. 2007/004511

### SUMMARY OF INVENTION

### Technical Problem

It is desired to reduce the equivalent series resistance (ESR) and a leakage current in a solid electrolytic capacitor. An object of the present disclosure is to provide a solid electrolytic capacitor of which the ESR is low and a leakage current is small.

### Solution to Problem

An aspect of the present disclosure relates to a solid electrolytic capacitor. The solid electrolytic capacitor is a solid electrolytic capacitor including: an anode body that is a porous sintered body; an anode wire protruding from an end surface of the anode body; a dielectric layer formed on a surface of the anode body; a solid electrolyte layer formed on the dielectric layer; a carbon layer formed on the solid electrolyte layer; and a silver particle layer containing silver particles and of which at least a portion is formed on the carbon layer, wherein the anode body has a bottom surface opposite to the end surface and a side surface connecting the end surface and the bottom surface, the solid electrolyte layer is formed in such a manner as to cover the entire bottom surface, the entire side surface, and at least a portion of the end surface, the carbon layer is formed in such a manner as to cover the entire bottom surface and a portion of the side surface, and not to cover the end surface, the silver particle layer is formed in such a manner as to cover the entire bottom surface and a portion of the side surface, and not to cover the end surface, when a distance from a first surface of the solid electrolyte layer formed on the bottom surface to a second surface of the solid electrolyte layer formed on the end surface is represented by L, the carbon layer is formed in such a manner as to cover a region of the side surface within a distance X from the first surface (where X satisfies 0.89≤X/L<1.00), and the silver particle layer is formed in such a manner as to cover a region of the side surface within a distance Y from the first surface (where Y satisfies 0.90≤Y/L<1.00).

### Advantageous Effects of Invention

According to the present disclosure, it is possible to obtain a solid electrolytic capacitor of which the ESR is low and a leakage current is small.

Although novel features of the present invention are described in the appended claims, the following detailed description referring to the drawings will further facilitate understanding of both the configuration and the content of the present invention as well as other objects and features of the present invention.

### BRIEF DESCRIPTION OF DRAWINGS

FIG. 1 is a cross-sectional view schematically showing an example of a solid electrolytic capacitor according to Embodiment 1.

FIG. 2 is a cross-sectional view showing an example of a structure of the solid electrolytic capacitor shown in FIG. 1.

FIG. 3 is a cross-sectional view showing another example of the structure of the solid capacitor according to Embodiment 1.

### DESCRIPTION OF EMBODIMENTS

The following describes example embodiments according to the present disclosure, but the present disclosure is not limited to the following examples. In the following description, specific numerical values and materials may be given as examples, but other numerical values and other materials may be applied as long as effects of the present disclosure can be obtained. In the present specification, the wording “from a numerical value A to a numerical value B” refers to a range that includes the numerical values A and B, and can be read as “the numerical value A or more and the numerical value B or less”. When examples of a lower limit and examples of an upper limit of numerical values relating to a specific physical property or condition are described in the following description, any of the examples of the lower limit and any of the examples of the upper limit may be combined suitably as long as the lower limit is not equal to or higher than the upper limit. When examples of a constituent element are listed in the following description, it is possible to use only one of the listed examples or two or more of the listed examples in combination, unless otherwise stated.

### (Solid Electrolytic Capacitor)

A solid electrolytic capacitor according to the present embodiment may be hereinafter referred to as a “solid electrolytic capacitor(S)”. The solid electrolytic capacitor(S) includes an anode body that is a porous sintered body, an anode wire protruding from an end surface of the anode body, a dielectric layer formed on a surface of the anode body, a solid electrolyte layer formed on the dielectric layer, a carbon layer formed on the solid electrolyte layer, and a silver particle layer that contains silver particles and of which at least a portion is formed on the carbon layer. Out of surfaces of the sintered body, the end surface from which the anode wire protrudes may be hereinafter referred to as “the end surface (e)”. The anode body has a bottom surface opposite to the end surface (e) and a side surface connecting the end surface (e) and the bottom surface. The bottom surface and the side surface may be hereinafter referred to as “the bottom surface (b)” and “the side surface(s)”. The solid electrolyte layer is formed in such a manner as to cover the entire bottom surface (b), the entire side surface(s), and at least a portion of the end surface (e). The carbon layer is formed in such a manner as to cover the entire bottom surface (b) and a portion of the side surface(s), and not to cover the end surface (e). The silver particle layer is formed in such a manner as to cover the entire bottom surface (b) and a portion of the side surface(s), and not to cover the end surface (e). A distance from a first surface of the solid electrolyte layer formed on the bottom surface (b) to a second surface of the solid electrolyte layer formed on the end surface (e) will be represented by L. The carbon layer is formed in such a manner as to cover a region of the side surface(s) within a distance X from the first surface (where X satisfies 0.89≤X/L<1.00). The silver particle layer is formed in such a manner as to cover a region of the side surface(s) within a distance Y from the first surface (where Y satisfies 0.90≤Y/L<1.00).

More specifically, the solid electrolyte layer is formed in such a manner as to cover the predetermined surfaces of the anode body via the dielectric layer. Even in this case, the solid electrolyte layer does cover the predetermined surfaces of the anode body. Therefore, if a specific constituent member A is formed in such a manner as to cover the anode body via a specific layer, this configuration may be described as “the constituent member A is formed in such a manner as to cover the anode body” in this specification.

The carbon layer and the silver particle layer are used as conductive layers (cathode lead-out layers) formed on the solid electrolyte layer in the solid electrolytic capacitor(S). In general, it is thought that the larger the area of a cathode lead-out layer is, the further the equivalent series resistance (ESR) decreases. In the solid electrolytic capacitor described in PTL 1, the conductive layer is also formed on an end surface of the sintered body to which the anode lead (anode wire) is connected, out of surfaces of the sintered body. However, the inventors of the present application newly found through studies that a leakage current significantly increases if a cathode lead-out layer is formed on the end surface (e). The present disclosure is based on this new finding.

In the solid electrolytic capacitor(S), the carbon layer and the silver particle layer are formed in such a manner as to cover an entire region within a distance of 0.89 L from the bottom surface (b) or an entire region within a distance of 0.90 L from the bottom surface (b) in the side surface(s) of the anode body. Therefore, the ESR can be reduced. Moreover, the carbon layer and the silver particle layer are not formed on the end surface (e) of the sintered body. With this configuration, the leakage current can be suppressed to be small. Reasons for this are not clear at present, but can be considered as follows. Materials having different shapes coexist in the end surface (e) at which the anode wire is joined to the porous sintered body, and there is stress generated during the formation in the end surface, and accordingly, the dielectric layer formed on the end surface is unstable. It is thought that, therefore, if the cathode lead-out layers (the carbon layer and the silver particle layer) attach to the end surface (e), a leakage current is likely to occur.

In the solid electrolytic capacitor(S), the cathode lead-out layers are not formed on the end surface (e). Accordingly, there is no need to form an insulating layer (an insulating layer other than the dielectric layer) or the like for reducing the leakage current on the end surface (e).

X/L is 0.89 or more, and may be 0.90 or more, or 0.95 or more. X/L is less than 1.00, and may be 0.99 or less, 0.98 or less, or 0.97 or less. Y/L is 0.90 or more, and may be 0.95 or more. Y/L is less than 1.00, and may be 0.99 or less, 0.98 or less, or 0.97 or less. The ESR can be reduced particularly when X/L and/or Y/L is set to 0.95 or more. The cathode lead-out layers can be formed easily when X/L and/or Y/L is set to 0.99 or less (e.g., 0.98 or less, or 0.97 or less).

The distance L and the distance X described above may satisfy a relationship: 0.95≤X/L<1.00 (e.g., 0.95≤X/L≤0.99 or 0.95≤X/L≤0.98), and the distance L and the distance Y described above may satisfy a relationship: 0.95≤Y/L<1.00 (e.g., 0.95≤Y/L≤0.99 or 0.95≤Y/L≤0.98). The ESR becomes particularly low with this configuration.

Although most of the silver particle layer is formed on the carbon layer, a portion of the silver particle layer may be formed on the solid electrolyte layer. A configuration is also possible in which the entire silver particle layer is formed on the carbon layer. The ESR can be reduced particularly when the carbon layer is present between the solid electrolyte layer and the silver particle layer. Note that the distance X described above may be smaller than the distance Y described above.

From another viewpoint, the solid electrolytic capacitor(S) includes cathode lead-out layers formed in such a manner as to cover an entire bottom surface (b) and a portion of a side surface(s) of a solid electrolyte layer, and not to cover an end surface (e) of the solid electrolyte layer. The cathode lead-out layers include a carbon layer formed on the solid electrolyte layer and a silver particle layer of which at least a portion is formed on the carbon layer. The cathode lead-out layers are formed in such a manner as to cover a region of the side surface(s) within a distance Z from the first surface described above (where Z satisfies 0.89≤Z/L<1.00). Z may also be 0.90 or more, or 0.95 or more.

A diameter D of the anode wire and a length W of a short side of the end surface (e) may satisfy 0.5≤D/W. In the solid electrolytic capacitor described in PTL 1, the conductive layer is also formed on the end surface (e). Accordingly, if the diameter of the anode wire (anode lead) is increased, a short circuit is likely to occur. On the other hand, the cathode lead-out layers are not formed on the end surface (e) in the solid electrolytic capacitor(S). Therefore, even if the diameter D of the anode wire is increased, a short circuit is unlikely to occur. The ESR can be reduced by increasing the diameter D of the anode wire. D/W may be within a range from 0.5 to 0.8 (e.g., from 0.5 to 0.7). However, D/W may also be smaller than 0.5. Note that the short side is the shortest side among sides of the end surface (e). If the end surface (e) is square, the length of a side of the square is the length W of the short side.

### (Method for Manufacturing Solid Electrolytic Capacitor (E))

The following describes an example of a method for manufacturing the solid electrolytic capacitor (E). However, the solid electrolytic capacitor (E) may also be manufactured using a method other than the following method. Each step described below may also be performed using a known method or a known method modified according to the present disclosure.

In the manufacturing method, first, an anode body (a porous sintered body) in which a portion of an anode wire is embedded is manufactured. Next, a dielectric layer is formed on a surface of the anode body. Next, a solid electrolyte layer is formed on the dielectric layer. The solid electrolyte layer may be formed by applying a liquid containing a material (e.g., a conductive polymer) of the solid electrolyte layer to the anode body, and then drying the applied liquid. In an example method for forming the solid electrolyte layer, first, the liquid is applied to the anode body by immersing the anode body in the liquid. Next, the applied liquid is dried. Thus, the solid electrolyte layer can be formed on the dielectric layer. Alternatively, the solid electrolyte layer may also be formed through electrolytic polymerization, chemical polymerization, or the like. The electrolytic polymerization and the chemical polymerization may be carried out under known conditions.

Next, a carbon layer and a silver particle layer are successively formed on the solid electrolyte layer. The carbon layer may be formed by applying a carbon paste containing particles of a carbonaceous material to the solid electrolyte layer, and then heating the applied carbon paste. The silver particle layer may be formed by applying a silver paste containing silver particles to the carbon layer, and then heating the applied silver paste. It is possible to use a carbon paste and a silver paste similar to carbon pates and silver pates used in the manufacture of known solid electrolytic capacitors. The carbon layer and the silver particle layer are formed in the regions described above.

The carbon paste may be applied by immersing the anode body provided with the solid electrolyte layer in the carbon paste, and then pulling up the anode body. It is possible to control the value X/L described above by changing the depth to which the anode body is immersed in the carbon paste. It is possible to control the thickness of the carbon layer by changing the speed at which the anode body is pulled up.

The silver paste may be applied by immersing the anode body provided with the carbon layer in the silver paste, and then pulling up the anode body. It is possible to control the value Y/L described above by changing the depth to which the anode body is immersed in the silver paste. It is possible to control the thickness of the silver particle layer by changing the speed at which the anode body is pulled up.

As described above, a capacitor element including the anode body, the anode wire, the dielectric layer, the solid electrolyte layer, and the cathode lead-out layers (the carbon layer and the silver particle layer) is formed. There is no particular limitation on subsequent steps, and steps necessary to manufacture the solid electrolytic capacitor are performed. For example, the following steps may be performed. First, an anode lead terminal is connected to the anode wire, and a cathode lead terminal is connected to the silver particle layer. The anode lead terminal may be connected to the anode wire through welding or the like. The cathode lead terminal may be connected to the cathode lead terminal via a conductive layer (e.g., a conductive adhesive layer such as another silver paste layer) or the like. Next, an exterior body is formed in such a manner as to cover a portion of the anode lead terminal, a portion of the cathode lead terminal, and the capacitor element. The exterior body can be formed using a sealing resin or the like. Thus, the solid electrolytic capacitor(S) is manufactured.

The following describes examples of the constituent elements of the solid electrolytic capacitor according to the present disclosure, but the configuration of the solid electrolytic capacitor(S) according to the present disclosure is not limited to the following example. Except for portions that are characteristic of the solid electrolytic capacitor(S), it is possible to use constituent elements that are used in known solid electrolytic capacitors(S) as the constituent elements of the solid electrolytic capacitor(S).

The solid electrolytic capacitor(S) includes a capacitor element, lead terminals (an anode lead terminal and a cathode lead terminal), and an exterior body. The capacitor element includes an anode portion, a dielectric layer, and a cathode portion. The anode portion includes an anode body and an anode wire. The dielectric layer is formed on a surface of the anode body. The dielectric layer may also be formed on a portion of the anode wire. The cathode portion includes a solid electrolyte layer and cathode lead-out layers. The cathode lead-out layers include a carbon layer and a silver particle layer formed on the carbon layer.

### (Anode Body)

The anode body is a porous sintered body. The anode body is formed by sintering particles that are used as the material of the anode body. Examples of the particles include particles of a valve metal, particles of an alloy containing a valve metal, and particles of a compound containing a valve metal. It is possible to use only one type of particles or a mixture of two or more types of particles from these particles. Titanium (Ti), tantalum (Ta), niobium (Nb), or the like is used as the valve metal.

The anode body has a columnar shape, for example, a rectangular parallelepiped shape. When the anode body has a rectangular parallelepiped shape, the anode body has an end surface (e), a bottom surface (b), and four side surfaces(s) connecting the end surface (e) and the side surface (b).

The anode body may be manufactured using the following method. First, a portion of the anode wire is embedded in powder (e.g., metal powder) that is used as the material of the anode body, and the powder is formed into a columnar shape (e.g., a rectangular parallelepiped shape) through compression molding. Thereafter, the powder is sintered to form the anode body. Thus, it is possible to manufacture the anode body in which a portion of the anode wire is embedded.

### (Dielectric Layer)

The dielectric layer is formed in such a manner as to cover the entire surface of the anode body. There is no particular limitation on the dielectric layer formed on the surface of the anode body, and the dielectric layer may be formed using a known method. For example, the dielectric layer may be formed by immersing the anode body in a chemical conversion liquid to cause anodic oxidation on the surface of the anode body. Alternatively, the dielectric layer may be formed by heating the anode body in an atmosphere containing oxygen to oxidize the surface of the anode body. When the anode body is a sintered body of tantalum, a dielectric layer formed of tantalum oxide is formed by oxidizing the surface of the sintered body of tantalum.

### (Anode Wire)

A metal wire can be used as the anode wire. Examples of the material of the anode wire include the above-described valve metal, copper, aluminum, an aluminum alloy, and the like. A portion of the anode wire is embedded in the anode body, and the remaining portion of the anode wire protrudes from the end surface (e) of the anode body. The anode wire has a rod-like shape.

### (Solid Electrolyte Layer)

There is no particular limitation on the solid electrolyte layer, and it is possible to use solid electrolyte layers that are used in known solid electrolytic capacitors. The solid electrolyte layer may also be a laminated body including two or more different solid electrolyte layers.

The solid electrolyte layer is disposed on the dielectric layer. As described above, the solid electrolyte layer is formed in such a manner as to cover the entire bottom surface (b), the entire side surface(s), and at least a portion of the end surface (e) of the anode body. The solid electrolyte layer may also be formed in such a manner as to cover an entire region of the end surface (e) other than a region from which the anode wire protrudes. That is to say, the solid electrolyte layer may also be formed in such a manner as to cover the entire surface of the anode body.

The solid electrolyte layer may be formed using a manganese compound or a conductive polymer. Examples of the conductive polymer include polypyrrole, polythiophene, polyaniline, and derivatives thereof. It is possible to use only one of these conductive polymers or a combination of two or more of these conductive polymers. The conductive polymer may be a copolymer of two or more monomers. Note that “derivatives of conductive polymers” mean polymers including the conductive polymers as basic skeletons. For example, examples of derivatives of polythiophene include poly(3,4-ethylenedioxythiophene).

It is preferable that a dopant is added to the conductive polymer. The dopant can be selected according to the conductive polymer, and a known dopant can be used. Examples of the dopant include naphthalenesulfonic acid, p-toluenesulfonic acid, polystyrene sulfonic acid, and salts thereof. An example of the solid electrolyte layer is formed using poly(3,4-ethylenedioxythiophene) (PEDOT) doped with polystyrene sulfonic acid (PSS).

The solid electrolyte layer containing a conductive polymer may be formed by polymerizing a raw material monomer on the dielectric layer. Alternatively, the solid electrolyte layer may also be formed by applying a liquid containing the conductive polymer (and a dopant as necessary) to the dielectric layer, and then drying the applied liquid.

### (Carbon Layer)

The carbon layer contains a carbonaceous material (a carbonaceous material having electrical conductivity) and has electrical conductivity. There is no particular limitation on the carbonaceous material. Examples of the carbonaceous material include graphite, carbon black, graphene flakes, carbon nanotubes, and the like. The carbon layer may contain only one carbonaceous material, or a plurality of carbonaceous materials. The thickness of the carbon layer may be within a range from 0.2 to 20 μm (e.g., from 1 to 3 μm).

The carbon layer may also contain, for example, a binder and/or an additive, as necessary. There is no particular limitation on the binder and the additive, and it is possible to use binders and additives that are used in carbon layers of known solid electrolytic capacitors. Examples of the binder include resins such as thermoplastic resins (e.g., polyester resin) and thermosetting resins (e.g., polyimide resin, epoxy resin). Examples of the additive include a dispersant, a surfactant, an antioxidant, an antiseptic, a base, an acid, and the like.

### (Silver Particle Layer)

The silver particle layer contains silver particles and has electrical conductivity. The thickness of the silver particle layer may be within a range from 5 to 100 μm (e.g., from 10 to 60 μm).

The silver particle layer may also contain, for example, a binder and/or an additive, as necessary. There is no particular limitation on the binder and the additive, and it is possible to use binders and additives that are used in silver particle layers of known solid electrolytic capacitors. Examples of the binder include resins such as thermoplastic resins (e.g., polyester resin) and thermosetting resins (e.g., phenolic resin, polyimide resin, epoxy resin, etc.). Examples of the additive include a dispersant, a surfactant, an antioxidant, an antiseptic, a base, an acid, and the like.

The carbon layer may contain particles of the carbonaceous material having an average particle diameter of 1 μm or less. The silver particle layer may contain silver particles having an average particle diameter of 1 μm or less. If conductive particles (particles of the carbonaceous material, silver particles) having a small average particle diameter are applied to the end surface (e), the applied conductive particles are likely to reach the dielectric layer on the end surface (e), and therefore, a leakage current is likely to increase. In the solid electrolytic capacitor(S), the cathode lead-out layers are not formed on the end surface (e), and therefore, even if conductive particles having a small average particle diameter are used, a leakage current at the end surface (e) does not increase. On the other hand, the ESR can be reduced by using conductive particles having a small average particle diameter. Note that the average particle diameter is a median diameter (D50) at which a cumulative volume reaches 50% in a particle size distribution on the volume basis. The average particle diameter (median diameter) can be determined using a laser diffraction/scattering particle size distribution measuring device.

### (Exterior Body)

There is no particular limitation on the exterior body. The exterior body may be formed using a resin material having insulating properties and used to seal capacitor elements.

The following describes an example of the solid electrolytic capacitor(S) according to the present embodiment with reference to the drawings. The constituent elements described above are applicable to constituent elements of the following example. The following example of the solid electrolytic capacitor may be modified based on the above description. Matters described below may also be applied to the embodiment described above.

### Embodiment 1

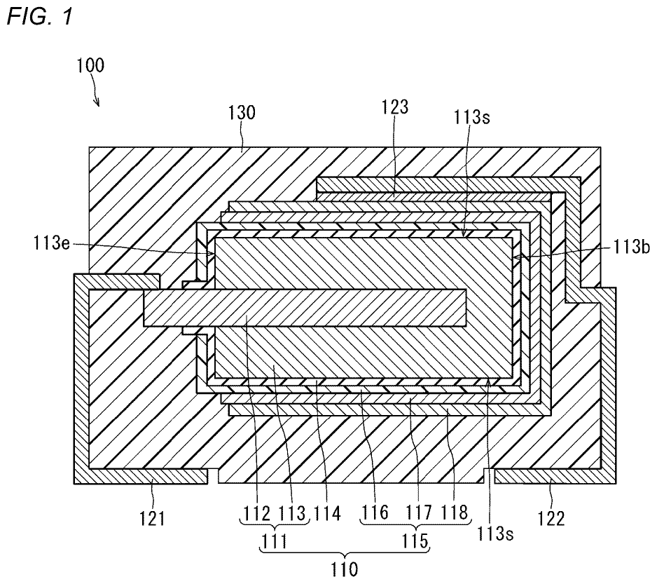

FIG. 1 is a cross-sectional view schematically showing a solid electrolytic capacitor according to Embodiment 1. A solid electrolytic capacitor 100 shown in FIG. 1 includes a capacitor element 110, an anode lead terminal 121, a cathode lead terminal 122, a conductive layer 123, and an exterior resin (exterior body) 130. The conductive layer 123 is formed from a silver paste or the like.

The capacitor element 110 includes an anode portion 111, a dielectric layer 114, and a cathode portion 115. The anode portion 111 includes an anode wire 112 and an anode body 113. The anode body 113 is a porous sintered body. The anode body 113 has a rectangular parallelepiped shape. The anode body 113 has an end surface 113e, a bottom surface 113b, and four side surfaces 113s. The end surface 113e has a substantially quadrilateral shape.

The anode wire 112 has a rod-like shape (a thin cylindrical shape). A portion of the anode wire 112 is embedded in the anode body 113, and the remaining portion of the anode wire 112 protrudes from the end surface 113e of the anode body 113. The anode lead terminal 121 is connected to the anode wire 112. The anode lead terminal 121 is electrically connected to the anode body 113 via the anode wire 112.

The dielectric layer 114 is formed in such a manner as to cover a portion of a surface of the anode wire 112 and the entire surface of the anode body 113. The cathode portion 115 includes a solid electrolyte layer 116, a carbon layer 117, and a silver particle layer 118. The carbon layer 117 and the silver particle layer 118 are the carbon layer and the silver particle layer described above. The cathode lead terminal 122 is connected to the silver particle layer 118 via the conductive layer 123. That is to say, the cathode lead terminal 122 is connected to the cathode portion 115 via the conductive layer 123. The carbon layer 117 and the silver particle layer 118 constitute cathode lead-out layers.

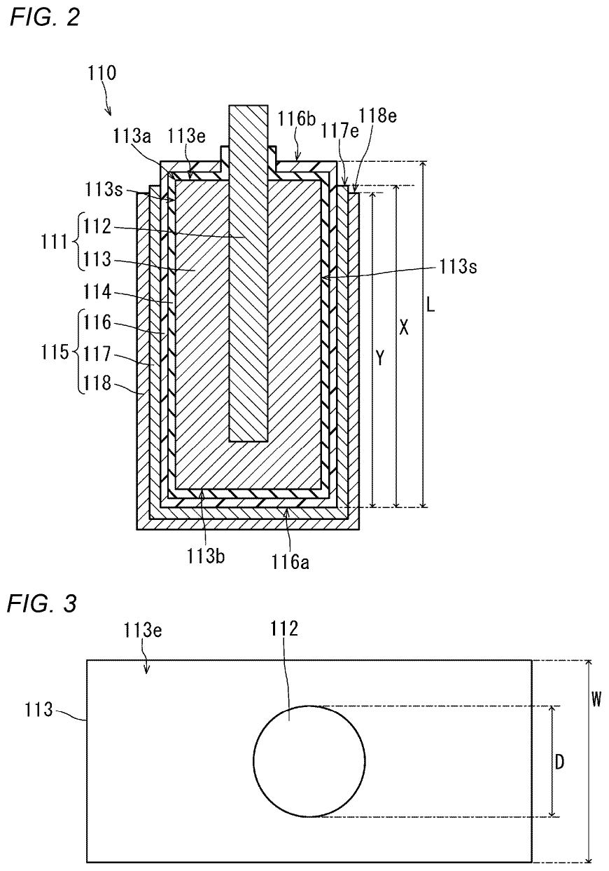

FIG. 2 schematically shows a cross-sectional view of the capacitor element 110. As shown in FIG. 2, a distance from a first surface 116a of the solid electrolyte layer 116 formed on the bottom surface 113b to a second surface 116b of the solid electrolyte layer 116 formed on the end surface 113e will be represented by L. The first surface 116a is the surface of a portion of the solid electrolyte layer 116 on the bottom surface 113b. The second surface 116b is the surface of a portion of the solid electrolyte layer 116 on the end surface 113e. The carbon layer 117 is formed in such a manner as to cover the bottom surface 113b and most of the side surfaces 113s. The carbon layer 117 covers a region of the side surfaces 113s within a distance X from the first surface 116a. The distance X between an end 117e of the carbon layer 117 and the first surface 116a and the distance L satisfy the relationship described above.

The silver particle layer 118 is formed in such a manner as to cover the bottom surface 113b and most of the side surfaces 113s. The silver particle layer 118 covers a region of the side surfaces 113s within a distance Y from the first surface 116a. The distance Y between an end 118e of the silver particle layer 118 and the first surface 116a and the distance L satisfy the relationship described above. The carbon layer 117 and the silver particle layer 118 are not formed in such a manner as to cover the end surface 113e. In other words, the carbon layer 117 and the silver particle layer 118 are not formed above the end surface 113e.

An example of the end surface 113e is shown in FIG. 3. FIG. 3 shows the diameter D of the anode wire 112 and the length W of a short side of the end surface 113e. As described above, the diameter D and the length W may satisfy 0.5≤D/W.

### SUPPLEMENTARY NOTES

The following technologies are disclosed by the above description.

### (Technology 1)

A solid electrolytic capacitor including:
an anode body that is a porous sintered body;
an anode wire protruding from an end surface of the anode body;
a dielectric layer formed on a surface of the anode body;
a solid electrolyte layer formed on the dielectric layer;
a carbon layer formed on the solid electrolyte layer; and
a silver particle layer that contains silver particles and of which at least a portion is formed on the carbon layer,
wherein the anode body has a bottom surface opposite to the end surface and a side surface connecting the end surface and the bottom surface,
the solid electrolyte layer is formed in such a manner as to cover the entire bottom surface, the entire side surface, and at least a portion of the end surface,
the carbon layer is formed in such a manner as to cover the entire bottom surface and a portion of the side surface, and not to cover the end surface,
the silver particle layer is formed in such a manner as to cover the entire bottom surface and a portion of the side surface, and not to cover the end surface,
when a distance from a first surface of the solid electrolyte layer formed on the bottom surface to a second surface of the solid electrolyte layer formed on the end surface is represented by L,
the carbon layer is formed in such a manner as to cover a region of the side surface within a distance X from the first surface (where X satisfies 0.89≤X/L<1.00), and
the silver particle layer is formed in such a manner as to cover a region of the side surface within a distance Y from the first surface (where Y satisfies 0.90≤Y/L<1.00).

### (Technology 2)

The solid electrolytic capacitor according to technology 1, wherein the distance L and the distance X satisfy a relationship: 0.95≤X/L<1.00, and
the distance L and the distance Y satisfy a relationship: 0.95≤Y/L<1.00.

### (Technology 3)

The solid electrolytic capacitor according to technology 1 or 2, wherein the entire silver particle layer is formed on the carbon layer.

### (Technology 4)

The solid electrolytic capacitor according to any one of technologies 1 to 3, wherein a diameter D of the anode wire and a length W of a short side of the end surface satisfy 0.5≤D/W.

### EXAMPLES

The following describes the solid electrolytic capacitor(S) according to the present disclosure in more detail using examples.

### Experiment Example 1

In Experiment Example 1, a plurality of solid electrolytic capacitors that differed from each other in the region where the carbon layer was formed were manufactured and evaluated.

### (Capacitor A1)

A capacitor A1 (solid electrolytic capacitor) having the same structure as the structure shown in FIG. 1 was manufactured as follows. First, a capacitor element was formed. A sintered body formed from tantalum particles was used as an anode body. A tantalum wire was used as an anode wire. A dielectric layer (tantalum oxide layer) was formed by oxidizing a surface of the sintered body of tantalum (porous sintered body). A solid electrolyte layer was formed using a conductive polymer.

Next, the anode body provided with the solid electrolyte layer was immersed in a carbon paste, and then pulled up and heated to form a carbon layer. At this time, the carbon layer was formed such that the value X/L described above was 0.89. Next, the anode body provided with the carbon layer was immersed in a silver paste, and then pulled up and heated to form a silver particle layer. The silver particle layer was formed such that the value Y/L described above was 0.95 or more and less than 1.00.

Next, an anode lead terminal was connected to the anode wire through welding. Also, a cathode lead terminal was connected to the silver particle layer using a silver paste. Next, a portion of the anode lead terminal, a portion of the cathode lead terminal, and the capacitor element were covered with an exterior resin. Thus, the capacitor A1 was manufactured.

### (Other Capacitors)

Capacitors A2, A3, and C1 to C3 were manufactured using the same method and the same conditions as those used in the manufacture of the capacitor A1, other than that the condition for forming the carbon layer was changed. Specifically, in the formation of the carbon layer, the value X/L described above was changed to values shown in Table 1. Note that the carbon layer attached to a portion of the end surface (e) of the sintered body in the capacitor C2. The entire end surface (e) was covered by the carbon layer in the capacitor C3.

The equivalent series resistance (ESR) and a leakage current were measured with respect to the manufactured solid electrolytic capacitors. The conditions for forming the carbon layer and evaluation results of the capacitors are shown in Table 1. In Table 1, the ESR and the leakage current are expressed as relative values when the ESR and the leakage current of the capacitor C1 were taken to be 1.0. Ratios of defective products shown in Table 1 indicate ratios of capacitors for which the leakage current was more than a predetermined amount. A lower ESR, a smaller leakage current, and a lower ratio of defective products are more preferable.

TABLE 1

| | | ESR | Leakage current | Ratio of |
|---|---|---|---|---|
| | | (relative | (relative | defective |
| Capacitor | X/L | value) | value) | products (%) |
| C1 | 0.79 | 1.0 | 1.0 | 0 |
| A1 | 0.89 | 0.91 | 1.3 | 0 |
| A2 | 0.95 | 0.87 | 1.5 | 0 |
| A3 | 0.99 | 0.87 | 1.2 | 0 |
| C2 | 1.00 | 0.88 | 15.0 | 5.4 |
| C3 | 1.00 (Note 1) | 0.88 | 18.1 | 5.7 |

(Note 1)
The end surface (e) was also covered by the carbon layer.

The capacitors A1 to A3 are solid electrolytic capacitors(S) according to the present disclosure. The capacitors C1 to C3 are comparative examples. As shown in Table 1, the ESRs of the capacitors A1 to A3 were lower than the ESR of the capacitor C1. Furthermore, the leakage currents of the capacitors A1 to A3 were significantly smaller than the leakage currents of the capacitors C2 and C3.

### Experiment Example 2

In Experiment Example 2, a plurality of solid electrolytic capacitors that differed from each other in the region where the silver particle layer was formed were manufactured and evaluated.

### (Capacitor B1)

A capacitor B1 was manufactured using the same method and the same conditions as those used in the manufacture of the capacitor A1 in Experiment Example 1, other than that the regions where the carbon layer and the silver particle layer were formed were changed. In the capacitor B1, the silver particle layer was formed such that the value Y/L was 0.90. The silver particle layer was formed by immersing the sintered body provided with the carbon layer in a silver paste, and then pulling up and heating the sintered body. The carbon layer was formed such that the value X/L was 0.95 or more and less than 1.00.

### (Other Capacitors)

Capacitors B2, B3, and C4 to C6 were manufactured using the same method and the same conditions as those used in the manufacture of the capacitor B1, other than that the condition for forming the silver particle layer was changed. Specifically, in the formation of the silver particle layer, the value Y/L described above was changed to values shown in Table 2. Note that the silver particle layer attached to a portion of the end surface (e) of the sintered body in the capacitor C5. The entire end surface (e) was covered by the silver particle layer in the capacitor C6.

The equivalent series resistance (ESR) and a leakage current were measured with respect to the manufactured solid electrolytic capacitors. The conditions for forming the silver particle layer and evaluation results of the capacitors are shown in Table 2. In Table 2, the ESR and the leakage current are expressed as relative values when the ESR and the leakage current of the capacitor C4 were taken to be 1.0. Ratios of defective products shown in Table 2 indicate ratios of capacitors for which the leakage current was more than a predetermined amount.

TABLE 2

| | | ESR | Leakage current | Ratio of |
|---|---|---|---|---|
| | | (relative | (relative | defective |
| Capacitor | Y/L | value) | value) | products (%) |
| C4 | 0.79 | 1.0 | 1.0 | 0 |
| B1 | 0.90 | 0.96 | 1.1 | 0 |
| B2 | 0.95 | 0.91 | 1.1 | 0 |
| B3 | 0.99 | 0.92 | 1.0 | 0 |
| C5 | 1.00 | 0.91 | 2.6 | 1.1 |
| C6 | 1.00 (Note 1) | 0.89 | 3.1 | 5.4 |

(Note 1)
The end surface (e) was also covered by the silver particle layer.

The capacitors B1 to B3 are solid electrolytic capacitors(S) according to the present disclosure. The capacitors C4 to C6 are comparative examples. As shown in Table 2, the ESRs of the capacitors B1 to B3 were lower than the ESR of the capacitor C4. Furthermore, the leakage currents of the capacitors B1 to B3 were significantly smaller than the leakage currents of the capacitors C5 and C6.

### INDUSTRIAL APPLICABILITY

The present disclosure is applicable to solid electrolytic capacitors.

Although the present invention has been described in terms of the presently preferred embodiment, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the invention.

### REFERENCE SIGNS LIST

100: solid electrolytic capacitor, 110: capacitor element, 111: anode portion, 112: anode wire, 113: anode body, 113b: bottom surface, 113e: end surface, 113s: side surface, 114: dielectric layer, 115: cathode portion, 116: solid electrolyte layer, 116a: first surface, 116b: second surface, 117: carbon layer, 118: silver particle layer

1. A solid electrolytic capacitor comprising:
an anode body that is a porous sintered body;
an anode wire protruding from an end surface of the anode body;
a dielectric layer formed on a surface of the anode body;
a solid electrolyte layer formed on the dielectric layer;
a carbon layer formed on the solid electrolyte layer; and
a silver particle layer that contains silver particles and of which at least a portion is formed on the carbon layer,
wherein the anode body has a bottom surface opposite to the end surface and a side surface connecting the end surface and the bottom surface,
the solid electrolyte layer is formed in such a manner as to cover the entire bottom surface, the entire side surface, and at least a portion of the end surface,
the carbon layer is formed in such a manner as to cover the entire bottom surface and a portion of the side surface, and not to cover the end surface,
the silver particle layer is formed in such a manner as to cover the entire bottom surface and a portion of the side surface, and not to cover the end surface,
when a distance from a first surface of the solid electrolyte layer formed on the bottom surface to a second surface of the solid electrolyte layer formed on the end surface is represented by L,
the carbon layer is formed in such a manner as to cover a region of the side surface within a distance X from the first surface (where X satisfies 0.89≤X/L<1.00), and
the silver particle layer is formed in such a manner as to cover a region of the side surface within a distance Y from the first surface (where Y satisfies 0.90≤Y/L<1.00).

2. The solid electrolytic capacitor according to claim 1,
wherein the distance L and the distance X satisfy a relationship: 0.95≤X/L<1.00, and
the distance L and the distance Y satisfy a relationship: 0.95≤Y/L<1.00.

3. The solid electrolytic capacitor according to claim 1,
wherein the entire silver particle layer is formed on the carbon layer.

4. The solid electrolytic capacitor according to claim 1,
wherein a diameter D of the anode wire and a length W of a short side of the end surface satisfy 0.5≤D/W.

5. The solid electrolytic capacitor according to claim 2,
wherein the entire silver particle layer is formed on the carbon layer.

6. The solid electrolytic capacitor according to claim 2,
wherein a diameter D of the anode wire and a length W of a short side of the end surface satisfy 0.5≤D/W.
